(19) United States
(12) Patent Application Publication
(10) Pub. No.: US 2023/0038376 A1
(43) Pub. Date: Feb. 9, 2023

(54) NOVEL CABLE AND CABLE-SEALING STRUCTURE OF CONNECTOR

(71) Applicant: GUANGZHOU AMPHENOL ELECTRONICS CO., LTD., GUANGZHOU (CN)

(72) Inventor: SHENPING LI, Guangzhou (CN)

(21) Appl. No.: 17/395,451

(22) Filed: Aug. 5, 2021

(51) Int. Cl. H01R 13/52

(52) U.S. Cl. CPC H01R 13/5221; H01R 13/5216

(57) ABSTRACT

Disclosed are a novel cable and a cable-sealing structure of a connector. The novel cable includes a conductor, an insulating layer, a shielding layer, an outer sheath, and a sealing protection ring. When the cable is installed inside a connector body, a circular seal is hooped outside the outer sheath at an area corresponding to a position of the sealing protection ring. When the circular seal presses the outer sheath of the cable, the sealing protection ring can support the outer sheath, so that the outer sheath may not be deformed. After long-term use or a high-temperature aging test, the outer sheath of the invention has a much smaller shrinkage of a diameter than an outer sheath without the sealing protection ring, therefore, the sealing performance and the safety of the connector are improved, and the service life of the connector is greatly prolonged.

### TECHNICAL FIELD

The invention relates to the technical field of connectors, and more particularly, to a novel cable and a cable-sealing structure of a connector.

### BACKGROUND OF THE PRESENT INVENTION

Generally, a commercially available cable nowadays includes a copper conductor, an insulating skin, a shielding layer, and an outer sheath. When connected to a connector, one end of the cable has to be inserted into the interior of the connector so that the copper conductor thereof is connected to a wiring part of the connector. Besides, to improve the sealing performance where the connector and the cable are connected, a circular seal is necessary between the connector and the cable. However, such a connector is defective in that: 1, after long-term use or a high-temperature aging test, an outer diameter of the cable may shrink due to the pressure applied by the circular seal, that is, the cable deforms, and the sealing performance deteriorates, losing the waterproof effect, and 2, when the cable deforms, failures will occur in the high-voltage insulation test and the insulation resistance test of the connector, bringing serious safety risks.

### SUMMARY OF THE PRESENT INVENTION

It is an object of the invention to overcome the defects in the prior art and provides a novel cable and a cable-sealing structure of a connector.

To achieve the above object, a first aspect of the present invention provides a novel cable, including:

a conductor;

an insulating layer provided outside the conductor along a length of the conductor;

a shielding layer provided outside the insulating layer along a length of the insulating layer;

an outer sheath provided outside the shielding layer along a length of the shielding layer; and

a sealing protection ring inserted between the shielding layer and the outer sheath and positioned at one end of the outer sheath.

The sealing protection ring is provided as a ring with a closed cross-section or as a C-shaped ring with an open cross-section.

One end of the sealing protection ring is provided with a flange extending radially, and the flange is exposed out of an end of the outer sheath.

The sealing protection ring is provided as a metal sealing ring or a rigid high-temperature-resistant plastic sealing ring.

The conductor is provided as a copper conductor; the shielding layer is provided as a shielding braid woven from a plurality of shielding wires.

A second aspect of the present invention provides a cable-sealing structure of a connector, including:

a connector body;

a cable having an end thereof installed inside the connector body and electrically connected with a wiring part of the connector body;

a circular seal provided inside the connector body and positioned between an inner wall of the connector body and the cable;

wherein the cable comprises:
a conductor;

an insulating layer provided outside the conductor along a length of the conductor;

a shielding layer provided outside the insulating layer along a length of the insulating layer;

an outer sheath provided outside the shielding layer along a length of the shielding layer; and

a sealing protection ring inserted between the shielding layer and the outer sheath and positioned at one end of the outer sheath, with the circular seal hooped outside the outer sheath at an area corresponding to a position of the sealing protection ring

The sealing protection ring is provided as a ring with a closed cross-section or as a C-shaped ring with an open cross-section.

One end of the sealing protection ring is provided with a flange extending radially, and the flange is exposed out of an end of the outer sheath.

The sealing protection ring is provided as a metal sealing ring or a rigid high-temperature-resistant plastic sealing ring.

The conductor is provided as a copper conductor; the shielding layer is provided as a shielding braid woven from a plurality of shielding wires.

The invention is more advantageous than the prior art in that:

The invention is simple in structure and scientifically designed. Because the sealing protection ring is provided between the shielding layer and the outer sheath, when the circular seal presses the outer sheath of the cable, the sealing protection ring can support the outer sheath, and the outer sheath may not be deformed. After long-term use or a high-temperature aging test, the outer sheath of the invention has a much smaller shrinkage of a diameter than an outer sheath without the sealing protection ring (the diameter of the outer sheath is basically unchanged), therefore, the sealing performance and the safety of the connector are improved, and the service life of the connector is greatly prolonged.

### BRIEF DESCRIPTION OF THE DRAWINGS

FIG. 1 is a sectional view showing a partial structure of a first novel cable;

FIG. 2 is a schematic view showing a structure of a first sealing protection ring;

FIG. 3 is a schematic view showing a structure of a second sealing protection ring;

FIG. 4 is a schematic view showing a structure of a third sealing protection ring;

FIG. 5 is a schematic view showing a structure of a fourth sealing protection ring;

FIG. 6 is a sectional view showing a partial structure of a second novel cable;

FIG. 7 is a sectional view of a first cable-sealing structure of a first connector; and

FIG. 8 is a sectional view of a second cable-sealing structure of a second connector.

### DETAILED DESCRIPTION OF THE PRESENT INVENTION

### Embodiment 1

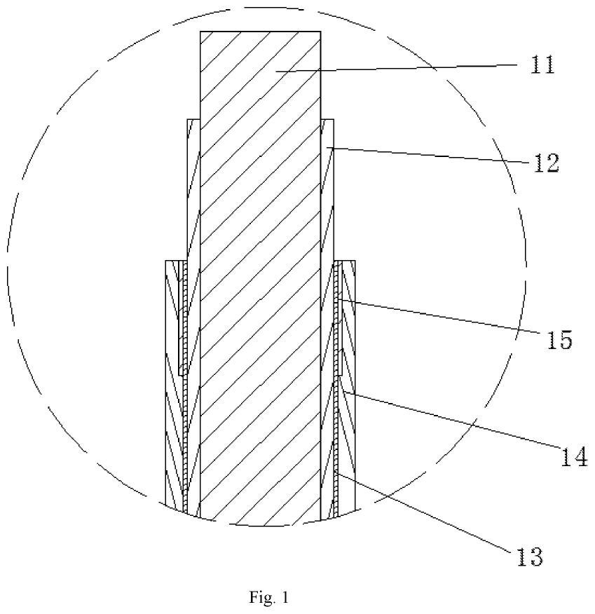

Referring to FIG. 1, an embodiment 1 of the present invention provides a novel cable including a conductor 11, an insulating layer 12, a shielding layer 13, an outer sheath 14, and a sealing protection ring 15, each of which is described in detail with reference to the accompanying drawings.

In this embodiment, the conductor 11 may preferably be provided as a copper conductor. Surely other conductors made of metallic conductive materials may be used as appropriate.

As shown in FIG. 1, the insulating layer 12 is disposed outside the conductor 11 along a length of the conductor 11, and the shielding layer 13 is disposed outside the insulating layer 12 along a length of the insulating layer 12. In this embodiment, the shielding layer 13 may be preferably provided as a shielding braid woven from a plurality of shielding wires.

As shown in FIG. 1, the outer sheath 14 is disposed outside the shielding layer 13 along a length of the shielding layer 13. The sealing protection ring 15 is inserted between the shielding layer 13 and the outer sheath 14 and is positioned at one end of the outer sheath 14 (i.e., the end interfacing the connector).

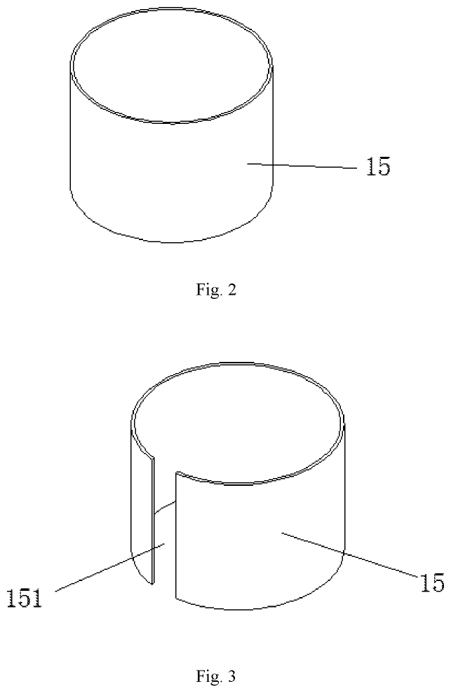

As shown in FIG. 2, the sealing protection ring 15 may preferably be provided as a ring with a closed cross-section and in a cylindrical shape, wherein the sealing protection ring 15 may preferably be provided as a metal sealing ring. Surely a rigid high-temperature-resistant plastic sealing ring or a sealing ring made of other rigid materials can be used as appropriate, not limited to this embodiment.

As shown in FIG. 3, in another embodiment, the sealing protection ring 15 may also be provided as a C-shaped ring having an opening 151 in cross-section, which further facilitates insertion of the sealing protection ring 15 between the shielding layer 13 and the outer sheath 14.

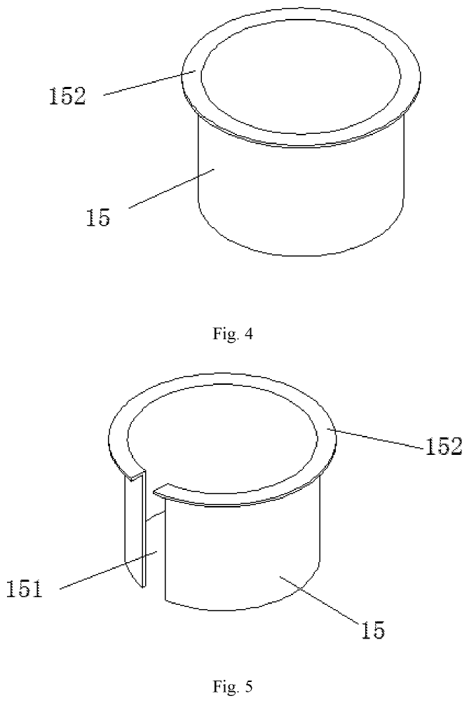

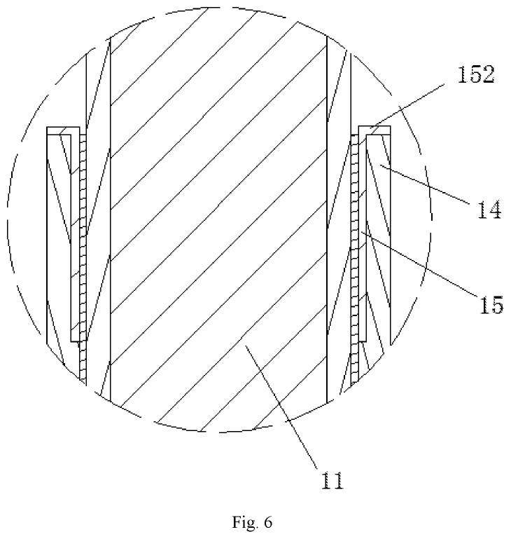

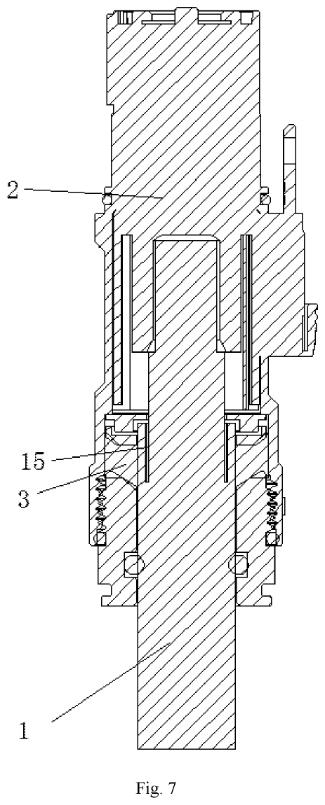

In addition, in other preferred embodiments, as shown in FIGS. 4 and 5, it is also possible to provide a flange 152 extending radially at one end of the sealing protection ring on the basis of a closed sealing protection ring or an open sealing protection ring according as appropriate. As shown in FIG. 6, when the sealing protection ring 15 is inserted between the shielding layer 13 and the outer sheath 14, the flange 152 is exposed out of the end of the outer sheath 14.

The flange 152 of the sealing protection ring 15 functions as a stop collar and can limit and contact the end of the outer sheath 14, so that the position of the sealing protection ring 15 is fixed. In addition, the flange 152 facilitates assembly and disassembly of the sealing protection ring 15 and enlarges an area of an end of the sealing protection ring 15, hence an operator can conveniently and quickly insert the sealing protection ring 15 between the shielding layer 13 and the outer sheath 14 and, in the case of disassembling the sealing protection ring 15, remove the sealing protection ring 15 easily by pulling the flange 15 with tools or by hands.

### Embodiment 2

Referring to FIG. 7, an embodiment 2 of the present invention provides a cable-sealing structure of a connector, including a cable 1, a connector body 2, and a circular seal 3, wherein one end of the cable 1 is installed inside the connector body 2 and electrically connected with a wiring part of the connector body 2, and the circular seal 3 is installed inside the connector body 2 and positioned between an inner wall of the connector body 2 and the cable.

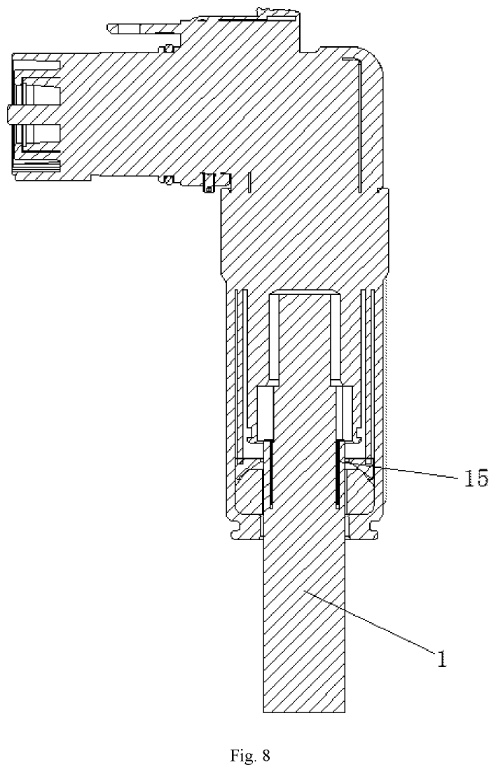

In a specific implementation, the connector body 2 may be provided as a straight connector (as shown in FIG. 7), a 90° bent connector (as shown in FIG. 8), a single-interface connector, a multi-interface connector, or various other connectors that need to be connected to a cable.

The structure and the mechanism of the cable of this embodiment are the same as those of the cable of the above-described embodiment 1, and also include a conductor 11, an insulating layer 12, a shielding layer 13, an outer sheath 14, and a sealing protection ring 15, which will not be described in detail here.

In the present embodiment, the circular seal 3 may be provided as a rubber circular seal, and the circular seal 3 is hooped outside the outer sheath 14 at an area corresponding to the position of the sealing protection ring 15.

Because the sealing protection ring is provided between the shielding layer and the outer sheath, when the circular seal presses the outer sheath of the cable, the sealing protection ring can support the outer sheath, and the outer sheath may not be deformed. After long-term use or a high-temperature aging test, the outer sheath of the invention has a much smaller shrinkage of a diameter than an outer sheath without the sealing protection ring (the diameter of the outer sheath is basically unchanged), therefore, the sealing performance and the safety of the connector are improved, and the service life of the connector is greatly prolonged.

The above-described embodiments are preferred ones of the present invention, but the embodiment of the present invention is not limited to the above-described embodiments, and any other changes, modifications, substitutions, combinations, simplifications, which do not depart the spirit and principles of the present invention, are all deemed as the equivalent replacement and intended to be included in the scope of the present invention.

1. A novel cable, comprising:
a conductor;
an insulating layer provided outside the conductor along a length of the conductor;
a shielding layer provided outside the insulating layer along a length of the insulating layer;
an outer sheath provided outside the shielding layer along a length of the shielding layer; and
a sealing protection ring inserted between the shielding layer and the outer sheath and positioned at one end of the outer sheath.

2. The novel cable according to claim 1, wherein the sealing protection ring is provided as a ring with a closed cross-section or as a C-shaped ring with an open cross-section.

3. The novel cable according to claim 2, wherein one end of the sealing protection ring is provided with a flange extending radially, and the flange is exposed out of an end of the outer sheath.

4. The novel cable according to claim 1, wherein the sealing protection ring is provided as a metal sealing ring or a rigid high-temperature-resistant plastic sealing ring.

5. The novel cable according to claim 1, wherein the conductor is provided as a copper conductor; the shielding layer is provided as a shielding braid woven from a plurality of shielding wires.

6. A cable-sealing structure of a connector, comprising:
a connector body;
a cable having an end thereof installed inside the connector body and electrically connected with a wiring part of the connector body;
a circular seal provided inside the connector body and positioned between an inner wall of the connector body and the cable;
wherein the cable comprises:
a conductor;
an insulating layer provided outside the conductor along a length of the conductor;
a shielding layer provided outside the insulating layer along a length of the insulating layer;
an outer sheath provided outside the shielding layer along a length of the shielding layer; and
a sealing protection ring inserted between the shielding layer and the outer sheath and positioned at one end of the outer sheath, with the circular seal hooped outside the outer sheath at an area corresponding to a position of the sealing protection ring

7. The cable-sealing structure of the connector according to claim 6, wherein the sealing protection ring is provided as a ring with a closed cross-section or a C-shaped ring with an open cross-section.

8. The cable-sealing structure of the connector according to claim 7, wherein one end of the sealing protection ring is provided with a flange extending radially, and the flange is exposed out of an end of the outer sheath.

9. The cable-sealing structure of the connector according to claim 6, wherein the sealing protection ring is provided as a metal sealing ring or a rigid high-temperature-resistant plastic sealing ring.

10. The cable-sealing structure of the connector according to claim 6, wherein the conductor is provided as a copper conductor; the shielding layer is provided as a shielding braid woven from a plurality of shielding wires.
